(19) United States
(12) Patent Application Publication
(10) Pub. No.: US 2017/0366641 A1
(43) Pub. Date: Dec. 21, 2017

(54) SOCIAL NETWORKING PLATFORM THAT PROVIDES UNIVERSAL PROFILES

(71) Applicant: SWOP, INC., Provo, UT (US)

(72) Inventors: John Mitchell Fultz, Provo, UT (US); Daniel Gene Collingridge, Spanish Fork, UT (US); Bryan Lloyd Anderson, Farmington, UT (US); William Madison Clifton, III, Cincinnati, OH (US); Eric Jeffrey Bateman, San Jose, CA (US); Scott Patrick Davis, Little Rock, AR (US); Yuvraj Parihar, Palo Alto, CA (US)

(21) Appl. No.: 15/188,191

(22) Filed: Jun. 21, 2016

(51) Int. Cl. H04L 29/08; H04W 4/02; H04L 12/58; H04W 8/20

(52) U.S. Cl. CPC H04L 67/306; H04W 8/20; H04W 4/023; H04L 51/20; H04L 51/24; H04L 51/32

(57) ABSTRACT

A social networking platform can provide universal profiles. A universal profile can define a user's account on the social networking platform of the present invention and can include a number of different endpoints by which the user can establish channels with other users. These endpoints can include a phone number endpoint and an email endpoint as well as a number of endpoints pertaining to the user's profiles with other social networking platforms. A user can define which endpoints will be included in his or her universal profile. Then, when other users view the user's universal profile, they will be able to see which endpoints the user has included and will be able to create a channel with the user via any of the endpoints.

### CROSS-REFERENCE TO RELATED APPLICATIONS

N/A

### BACKGROUND

A number of different social networking platforms have become widely used. As a result, a typical user will have an account with multiple different social networking platforms. For example, it is common for a user to have a Facebook account, a LinkedIn account, a Twitter account, a Google+ account, an Instagram account, a Pinterest account, etc. Because of the number of popular social networking platforms, it can be difficult to fully connect with another individual/entity. For example, if one individual meets another individual and desires to fully connect with that individual, the individual may need to obtain the other individual's account identifier in each of the social networking platforms with which the other individual has an account.

Oftentimes, connecting with another individual is accomplished by searching for the other individual on each social networking platform which can be a tedious and error-prone process. For example, when searching with another individual's name alone, it is likely that a large number of results will be found. It can be difficult to parse through these results to identify the correct account. Also, a seemingly correct account may turn out to be someone else's account. Further, if the individual happens to forget the other individual's name or account identifier before having an opportunity to connect on a social networking platform, there may be no reasonable way of locating the other individual's account.

Even in situations where the individual has all the information that is necessary to connect with the other individual, the process of connecting on multiple social networking platforms can require a substantial amount of time. For example, the individual may be required to log into each social networking platform, search for the other individual's account, and then request connection with the other individual. Because of these difficulties, many users will choose to be active in relatively few social networking platforms or will spend an inordinate amount of time connecting with other individuals.

### BRIEF SUMMARY

The present invention extends to methods, systems, and computer program products for implementing a social networking platform that provides universal profiles. A universal profile can define a user's account on the social networking platform of the present invention and can include a number of different endpoints by which the user can establish channels with other users. These endpoints can include a phone number endpoint and an email endpoint as well as a number of endpoints pertaining to the user's profiles with other social networking platforms. A user can define which endpoints will be included in his or her universal profile. Then, when other users view the user's universal profile, they will be able to see which endpoints the user has included and will be able to create a channel with the user via any of the endpoints.

The social networking platform of the present invention can also provide location technology to locate nearby users. When a user is logged into his or her account on a mobile application, the social networking platform can employ a number of techniques to identify any other users that are nearby. These nearby users can be displayed to the user in real time to allow the user to easily obtain information about the nearby users and/or to connect with selected nearby users. Additionally, the social networking platform can track which users were nearby during a period of time. Then, at a later time, the user can review these tracked users to determine whether to connect with them. This tracking can include identifying which users were nearby as well as possibly a time, location, or other information about when each user was nearby. In this way, the user will not be burdened with accessing his or her mobile device to create channels while interacting with other users.

In one embodiment, the present invention is implemented as a method for creating a universal profile for a first user of a first social networking platform. Endpoint information can be received from the first user. The endpoint information can include one or more elements of contact information of the first user as well as one or more social network designations. Each social network designation can identify another social networking platform with which the first user has a profile. A universal profile can then be generated for the first user. The universal profile can include an endpoint for each element of contact information and for each social network designation included in the input. A representation of the universal profile can be displayed to a second user. The representation can include an indication for each endpoint included in the universal profile.

In another embodiment, the present invention is implemented as computer storage media storing computer executable instructions which when executed by one or more processors of one or more computing devices implement a method for creating a universal profile for a first user of a first social networking platform. Endpoint information can be received from a first user. The endpoint information can include a phone number, an email address, and a social network designation which identifies another social networking platform with which the first user has a profile. A universal profile can be generated for the first user. The universal profile can include a phone number endpoint, an email endpoint, and a social network endpoint that are generated based on the endpoint information.

In another embodiment, the present invention can be implemented as a social networking platform that includes one or more servers on which universal profiles of users of the social networking platform are stored. Each universal profile defines at least one endpoint. The social networking platform can also include a mobile application configured to communicate with the one or more servers. Each mobile application can be configured to report a location of a corresponding user of the social networking platform. The one or more servers are configured to detect, during a period of time, when one or more other users are nearby a first user and to store, for each nearby user, an identification of the nearby user. The one or more servers are also configured to display, to the first user and at a time subsequent to the period of time, each stored identification thereby enabling the first user to identify which users were nearby during the period of time.

This summary is provided to introduce a selection of concepts in a simplified form that are further described below in the Detailed Description. This Summary is not intended to identify key features or essential features of the claimed subject matter.

### BRIEF DESCRIPTION OF THE DRAWINGS

Understanding that these drawings depict only typical embodiments of the invention and are not therefore to be considered limiting of its scope, the invention will be described and explained with additional specificity and detail through the use of the accompanying drawings in which:

FIG. 1 illustrates an example architecture of a social networking platform that can provide universal profiles;

FIG. 2 illustrates how a universal profile can be created;

FIG. 3 illustrates contents of an example universal profile;

FIGS. 3A and 3B illustrate examples of how the universal profile of FIG. 3 can be displayed;

FIGS. 4A and 4B illustrate how a channel can be manually created between two users;

FIG. 5 illustrates how a channel can be automatically created between two users based on the users being connected in another social networking platform;

FIG. 6 illustrates how a channel can be automatically created between two users based on one user having the other user's phone number or email address in his or her contact book;

FIG. 7 illustrates how a user's connection can be displayed;

FIG. 8 illustrates how nearby users can be detected, displayed, and tracked;

FIG. 8A illustrates how the user can be presented with other users that the user was nearby during a previous period of time; and

FIG. 9 illustrates a flowchart of an example method for creating a universal profile for a first user of a first social networking platform.

### DETAILED DESCRIPTION

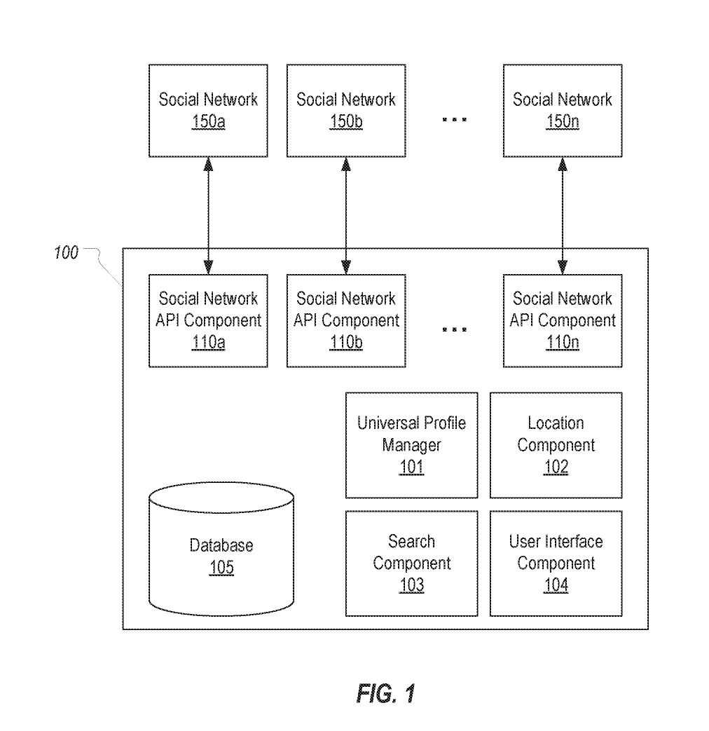

FIG. 1 illustrates an example of the computing architecture that can be employed to implement a social networking platform 100 that provides universal profiles. Social networking platform 100 can typically be structured in a client/server architecture where the client-side components are provided in the form of a mobile application or a website. However, any suitable architecture could be employed. For ease of illustration, the components of social networking platform 100 will not be specifically described as either server-side or client-side components with the understanding that these components could be configured in either or both manners.

As shown in FIG. 1, social networking platform 100 can include a number of components which enable a user to create, update, and view his or her universal profile as well as to explore and connect with universal profiles of other users. For example, social networking platform 100 can include a universal profile manager 101 which, for purposes of this description, will represent the component(s) that perform the functionality of creating and updating a universal profile. Although this description will focus on universal profiles of people, an entity (e.g., a company, an organization, a foundation, etc.) can create a universal profile to represent the entity.

Social networking platform 100 also includes a database 105 in which universal profiles can be stored and a search component 103 for searching for other users on social networking platform 100. User interface component 104 represents the component(s) that generate a user interface by which the user can interact with social networking platform 100. For example, social networking platform 100 can provide a web-based and/or mobile-application-based user interface as is common among the many social networking platforms that are available.

A universal profile can include a number of different “channel endpoints” or simply endpoints by which the user can connect (or form channels) with other users. For example, a universal profile can include a phone number endpoint and an email endpoint. A user can be viewed as having a channel with another user via the phone number endpoint or the email endpoint if the user has the other user's phone number or email address respectively. A universal profile may also include a number of social network endpoints which each represent the user's profile in another social networking platform. For example, a universal profile can include a Facebook endpoint which represents the user's Facebook profile or a LinkedIn endpoint which represents the user's LinkedIn profile. Accordingly, when viewing another user's universal profile, the user will be able to identify which endpoint the other user has included in his or her universal profile and therefore identify each potential channel that the other user could establish with the user.

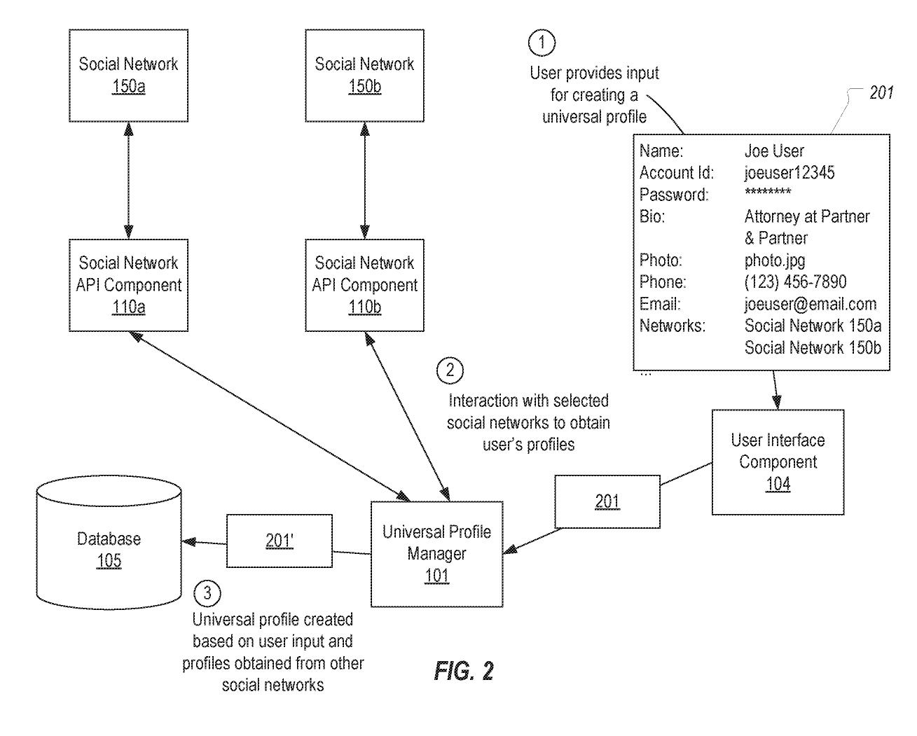

FIG. 2 illustrates an example of how a user can create a universal profile with social networking platform 100. For purposes of this example, it will be assumed that a user is employing a mobile application on a mobile device (e.g., a smart phone) to initiate the depicted functionality. However, the user could also initiate this functionality by accessing a website of social networking platform 100 on any type of computing device, or by accessing any other type of suitable interface that could grant access to social networking platform 100.

In FIG. 2, step 1 indicates that the user has provided input 201 for creating a universal profile. This input can be provided in any suitable manner such as via one or more interfaces that user interface component 104 generates to solicit this input. As shown, input 201 can include general information that is commonly employed to create a user profile with a social network including the user's name (Joe User), an account identifier that is unique within social networking platform 100 (joeuser12345), a password, a bio that provides additional information about the user (that Joe User is an attorney at Partner & Partner), and a photo.

Input 201 may also include endpoint information that can be employed to create endpoints within the user's universal profile. For example, input 201 includes a phone number for creating a phone number endpoint, an email address for creating an email endpoint, and social network information for creating social network endpoints. In typical embodiments, a user may be required to provide a phone number and an email address in order to create a universal profile while the provision of social network information may be optional.

In FIG. 2, the social network information contained in input 201 includes a designation of social network 150a and a designation of social network 150b. As an example, social network 150a can represent LinkedIn while social network 150b can represent Facebook. In some embodiments, these designations could have been generated in response to the user selecting a LinkedIn icon and a Facebook icon (among a number of other possible social network icons) within one or more user interfaces displayed to solicit input 201.

The designation of social networks 150a and 150b in input 201 can generally represent whatever subsequent input is required of the user to allow universal profile manager 101 to access the user's profile with the corresponding social networking platform. The exact type of input that will be required depends largely on the type of interactions that the other social networking platforms allow others to make. For example, Twitter provides native integration with a user's mobile device which would allow social networking platform 100 to obtain access to the user's Twitter account in response to the user simply confirming social networking platform 100's request for authorization. Other social networking platforms may require switching over to the platform's mobile application where the user can confirm that social networking platform 100 should be allowed access to the user's profile. In either of these cases, social networking platform 100 would be able to obtain the user's account identifier and/or any other authentication information necessary to access the user's profile. With other social networking platforms, the user may be required to input the user's account identifier with the social networking platform and/or any other necessary authentication information and/or authorization input. In any case, in addition to specifying which social network endpoints the user would like included in his or her universal profile, the user can also provide any necessary input to allow social networking platform 100 to access the user's profile with any specified social networking platform.

Upon or while obtaining input 201 and performing any necessary interactions with the user to obtain authorization to access the user's profile with any specified social networking platform, user interface component 104 can pass input 201 onto universal profile manager 101. In a step 2 (which is not necessarily performed after step 1 is completed or before commencing step 3), universal profile manager 101 can access social networks 150a and 150b via corresponding social network API components 110a and 110b to access the user's profiles with these social networking platforms. As indicated above, social networking platforms 150a and 150b are assumed to represent LinkedIn and Facebook respectively in this example. Accordingly, social network API components 110a and 110b represent the components of social networking platform 100 that are configured to interact with LinkedIn and Facebook respectively to access the user's LinkedIn and Facebook profiles.

In step 3, universal profile manager 101 employs input 201 and additional information obtained from social networking platforms 150a and 150b (collectively input 201′) to create a universal profile for Joe User. As will be further described below, this additional information that may be obtained from LinkedIn and Facebook can include Joe User's connections/friends on LinkedIn and Facebook. Because input 201 included Joe User's phone number, email address, a designation of LinkedIn, and a designation of Facebook, Joe User's universal profile will include four endpoints: a phone number endpoint, an email endpoint, a LinkedIn endpoint, and a Facebook endpoint.

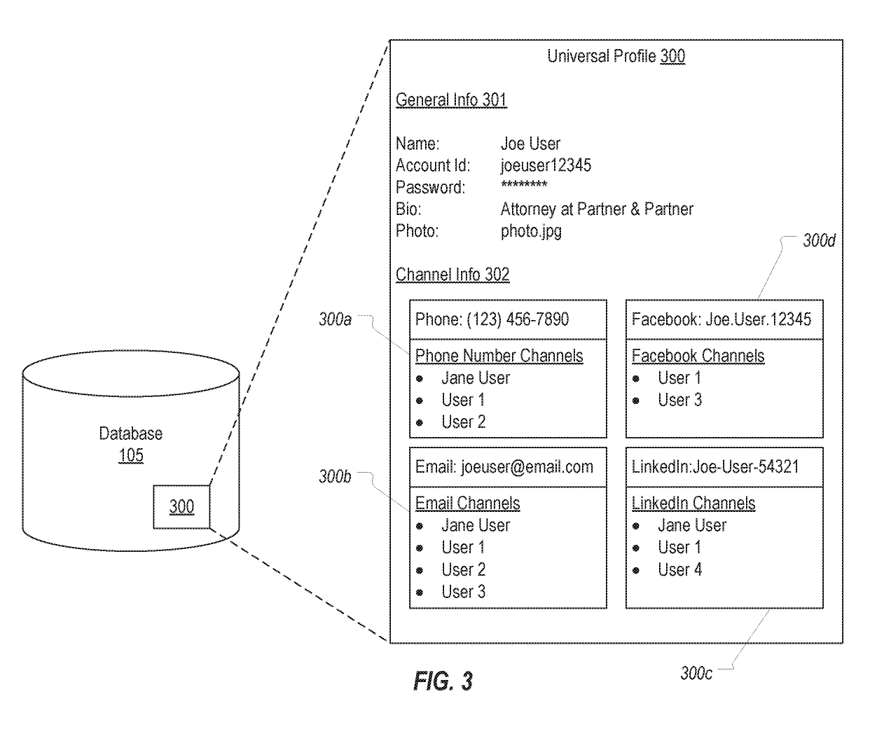

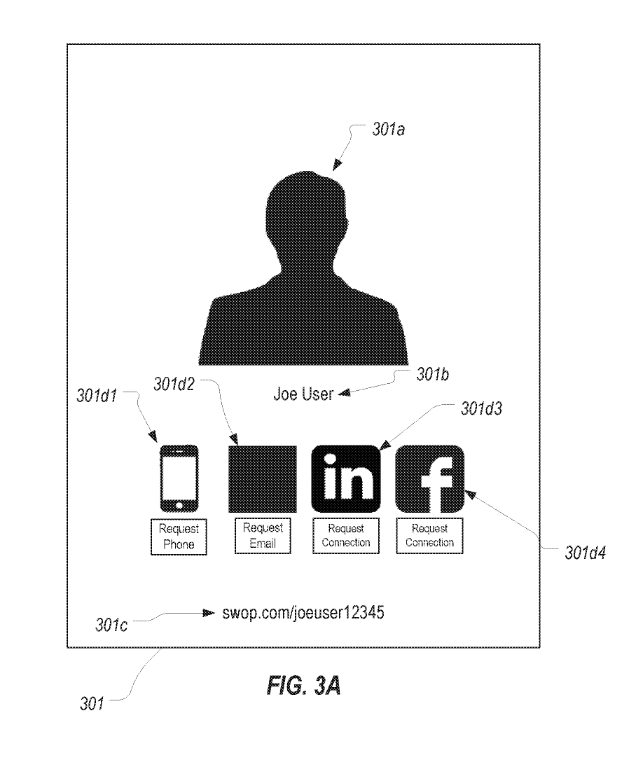

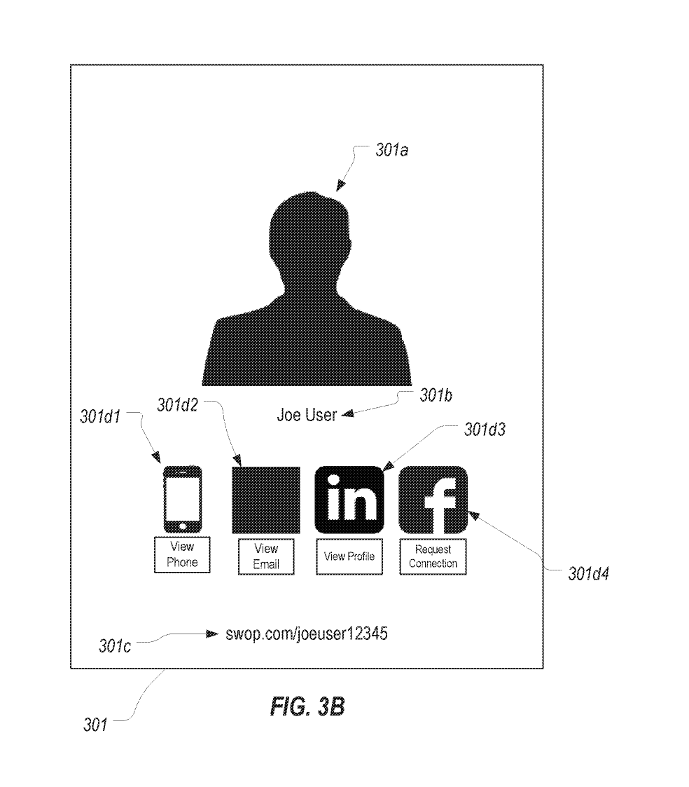

FIG. 3 provides an example of the contents of a universal profile 300 that can be created in database 105 in response to input 201. A universal profile 300 can be structured in any suitable manner including as one or more tables of a relational database. Universal profile 300 includes general information 301 including the name (Joe User), account Id (joeuser12345), password, bio, and photo (photo.jpg) that Joe User specified in input 201. Universal profile 301 also includes endpoint/channel information 302 defining four different endpoints that Joe User has specified for inclusion in his universal profile and any channels that have been created for each endpoint. A phone number endpoint 300a can define Joe User's phone number (123-456-7890) and can include an indication of each phone number channel that has been created (i.e., an indication of each user whose phone number Joe User has received and/or has access to). Similarly, an email endpoint 300b can define Joe User's email address (joeuser@email.com) and can include an indication of each email channel that has been created (i.e., an indication of each user whose email address Joe User has received and/or has access to). As shown, the sets of users with which Joe User has shared his phone number and email address are not the same representing that social networking platform 100 provides granular control over how contact information is shared.

Additionally, universal profile 300 includes a LinkedIn endpoint 300c based on Joe User's LinkedIn profile and a Facebook endpoint 300d based on Joe User's Facebook profile. Each of these social network endpoints can define Joe User's account identifier with the corresponding social networking platform and can include an indication of each social network channel that has been created (i.e., each of Joe User's connections/friends (hereinafter generally “connections”) on those platforms). These connections can be obtained by universal profile manager 101 via the corresponding social network API component (e.g., during step 2 of FIG. 2 or at a later time). As will be further described below, the channels defined for a social network endpoint do not constitute a complete list of all of Joe User's connections on LinkedIn or Facebook, but are limited to Joe User's connections on those platforms that have also created a universal profile with social networking platform 100 and have included a LinkedIn and/or Facebook endpoint in their universal profiles. For example, User 1 is not only Joe's connection on LinkedIn and Facebook, but also has a universal profile with social networking platform 100 and has included a LinkedIn endpoint and a Facebook endpoint in his universal profile. Alternatively, it is possible that Joe User is connected with User 2 on Facebook and LinkedIn. However, if User 2 has not included a Facebook or LinkedIn endpoint in his or her universal profile, a Facebook or LinkedIn channel would not be created between Joe User and User 2.

In social networking platform 100, a user can be viewed as connected to another user if the user has established one or more channels with the other user. For example, Joe User's is connected with User 4 on social networking platform 100 due to the established LinkedIn channel even though Joe User has not shared his phone number or email address with User 4 and is not Facebook friends with User 4.

FIG. 3A provides an example of a user interface 301 that can be employed to display a universal profile. In this example, user interface 301 displays Joe User's universal profile 300, and it will be assumed that Joe User's universal profile 300 is being viewed by another user that is not connected to Joe User (i.e., has not established any channels with Joe User). User interface 301 includes a photo 301a of Joe User, Joe User's name 301b, and a universal link 301c to Joe User's universal profile 300. User interface 301 can also include a number of icons 301d1-301d4 which identify which endpoints Joe User has included in universal profile 300. In particular, user interface 301 includes a phone icon 301d1, an email icon 301d2, a LinkedIn icon 301d3, and a Facebook icon 301d4 which represent Joe User's phone number endpoint, email endpoint, LinkedIn endpoint, and Facebook endpoint respectively.

Any icon representing a social network endpoint can be selectable to allow Joe User's profile with the corresponding social networking platform to be viewed. For example, if the user selects icon 301d3, Joe User's LinkedIn profile can be opened within the LinkedIn mobile application or within a browser (i.e., via linkedin.com). Similarly, if the user selects icon 301d4, Joe User's Facebook profile can be opened. In this way, the user can quickly obtain information about Joe User. If the user happens to be looking for a particular Joe User on social networking platform 100, this ability to quickly access each of Joe User's profiles with other social networking platforms will assist the user to quickly identify whether the correct Joe User has been found. Phone and email icons 301d1 and 301d2 can also be selectable to allow Joe User's phone number and email address to be viewed. However, because Joe User has not shared his phone number or email address with this viewing user (i.e., there is no phone number or email channel established between the two users), the selection of these icons will not present Joe User's phone number or email address.

In FIG. 3A, because the user viewing Joe User's universal profile 300 is assumed to not have any channels with Joe User, each of icons 301d1-301d4 can be displayed in conjunction with a request element. For example, phone icon 301d1 and email icon 301d2 can be displayed with a Request Phone element and a Request Email element respectively. Similarly, LinkedIn icon 301d3 and Facebook icon 301d4 can be displayed with Request Connection elements. In response to the selection of any of these elements, a corresponding request can be generated and sent to Joe User to inform Joe User of the other user's desire to obtain his phone number or email address or to connect on LinkedIn or Facebook. As will be further described below, if Joe User approves the request, the other user's universal profile (and possibly Joe User's universal profile 300) can be updated to reflect the creation of a channel.

It is noted that not all social networking platforms allow a connection to be created from outside their respective platforms. In such cases, a Request Connection icon may not be displayed. Instead, a View Profile icon or no icon at all may be displayed. In contrast, for social networking platforms that will allow it, universal profile manager 101 can respond to Joe User's acceptance of a request to connect on a particular social networking platform by performing the necessary interactions with the corresponding social network API component to create the connection in the particular social networking platform.

FIG. 3B provides another example of user interface 301. However, in this case, it is assumed that Jane User is viewing Joe User's universal profile 300. Because Jane User has established phone number, email, and LinkedIn channels with Joe User, user interface 301 can provide an indication of these channels. In this example, these indications are in the form of a View Phone element, a View Email element, and a View Profile element that are displayed in conjunction with icons 301d1-301d3 respectively. Because Jane User has not established a Facebook channel with Joe User, icon 301d4 is displayed with a Request Connection element.

These elements are only one example of how the status of a channel can be represented in a user interface and any suitable indication could be employed. Also, in addition to the connected status and not connected status of a channel that are depicted in FIGS. 3A and 3B, a channel may also have a request received status or a request sent status. For example, if Jane User selects the Request Connection element displayed with icon 301d4, a request to connect with Joe User on Facebook could be sent to Joe User. In response to this request, user interface 301 could be updated to reflect a status of “request sent” for the Facebook channel. Similarly, if Joe User were to view Jane User's universal profile after this request was sent, the Facebook icon 301d4 could be displayed with a “Request Received” element.

For a particular channel to be created between two users, each user must define an endpoint for that particular channel. As mentioned above, social networking platform 100 may require all users to include phone number and email endpoints in their profiles such that phone number and email channels can be created between any two users. However, for a social network channel to be created between two users, both users will need to have included the corresponding endpoint in their universal profiles.

Also, some channels may be one-way channels while others may be two-way channels. A one-way channel is a channel where a first user shares his information with a second user but the second user does not share the same information with the first user. For example, Joe User may have Jane User's phone number, but Jane User may not have Joe User's phone number. Another example of a one-way channel is when a first user follows a second user on a social networking platform but the second user does not follow the first user (e.g., in Twitter, Pinterest, Instagram, etc.). In some embodiments, social networking platform 100 may require that all phone number and email channels be two-way channels (i.e., a user cannot obtain another user's phone number without also sharing his or her phone number with the other user).

Social networking platform 100 can allow channels to be created in a number of different ways. For example, a channel can be created between two users based on one user requesting the channel and the other user accepting the request. For example, with reference to universal profile 300, the phone number channel between Joe User and Jane User could have been created in response to Joe User requesting Jane User's phone number and Jane User accepting the request. This type of channel creation will be referred to as manual creation. As indicated above, in some embodiments, a manually created phone number or email channel may always result in a two-way channel being created, while in other embodiments, a one-way channel may be permitted. In some embodiments, whether a two-way channel is created can be based on user input.

A channel can also be created automatically by social networking platform 100. For example, with reference to FIG. 2, when universal profile manager 101 accesses Joe User's LinkedIn and Facebook profiles to identify Joe User's connections on those social networking platforms, universal profile manager 101 may automatically create a LinkedIn or Facebook channel within universal profile 300 for any of Joe User's LinkedIn or Facebook connections that also have a universal profile that includes a LinkedIn or Facebook endpoint. A channel may also be automatically deleted if it is determined that a connection no longer exists between two users on another social networking platform.

Similarly, universal profile manager 101 could access Joe User's contact book to identify if the contact book stores the phone number or email address of any other user's universal profile. If so, a phone number or email channel could be automatically created to reflect that Joe User has already received the other user's phone number or email address.

The automatic creation or deletion of a channel could be performed at any time. For example, universal profile manager 101 could be configured to periodically access the user's contact book and the user's social network profiles to identify whether any channels should be created or any channels should be deleted. For example, if Joe User disconnects with Jane User on LinkedIn outside of social networking platform 100, universal profile manager 101 could detect this when performing a periodic access of Joe User's LinkedIn account. In response, universal profile manager 101 could update universal profile 300 to remove the LinkedIn channel with Jane User from LinkedIn endpoint 300c. A similar process could be performed if it is determined that Joe User has deleted Jane User's email address from his contact book. In either case, Joe User can be prompted prior to deleting any channel.

In some embodiments, a user may be allowed to remove his or her phone number or emails address from another user's contact book. For example, if Joe User connects with Jane User thereby causing Joe User's phone number to be added to Jane User's contact book, social networking platform 100 may provide the ability for Joe User to request the removal of his phone number from Jane User's contact book. In some cases, the removal of Joe User's phone number from Jane User's contact book could be performed automatically, such as, in response to Joe User deleting a phone number channel with Jane User. In such cases, social networking platform 100 may only allow a user to remove his or her phone number or email address from another user's contact book if social networking platform 100 had previously added the user's phone number or email address to the contact book (i.e., social networking platform 100 may not allow contact information to be removed from the contact book when the contact information was manually input by the user into the contact book or added to the contact book by an application other than social networking platform 100). In other embodiments, however, social networking platform 100 may allow a user to remove his or her contact information from another user's contact book if the other user had previously been or is currently a connection within social networking platform 100 regardless of how the contact information was stored in the contact book.

In some embodiments, social networking platform 100 may be configured to perform contact synchronization using information from universal profiles. For example, if two users create a phone number channel, social networking platform 100 can add the respective phone number to each user's contact book. Additionally, social networking platform 100 may synchronize other information contained in the respective universal profile (e.g., a photo of the user with whom the phone number channel was created) into the contact. This synchronization can include adding a new contact or updating an existing contact (e.g., adding a phone number to an existing contact or replacing a phone number in an existing contact). In some embodiments, such updates can be performed to a user's contact book automatically in response to a connection updating his or her phone number or email address within his or her universal profile.

In some embodiments, contacts that are added or updated in a contact book by social networking platform 100 can be placed into a group to distinguish contacts that are connections on social networking platform 100 from other contacts. In some embodiments, a contact that is added or updated by social networking platform 100 can be updated to include a link to the contact's universal profile. This link can be selected to open the contact's universal profile within social networking platform 100's application.

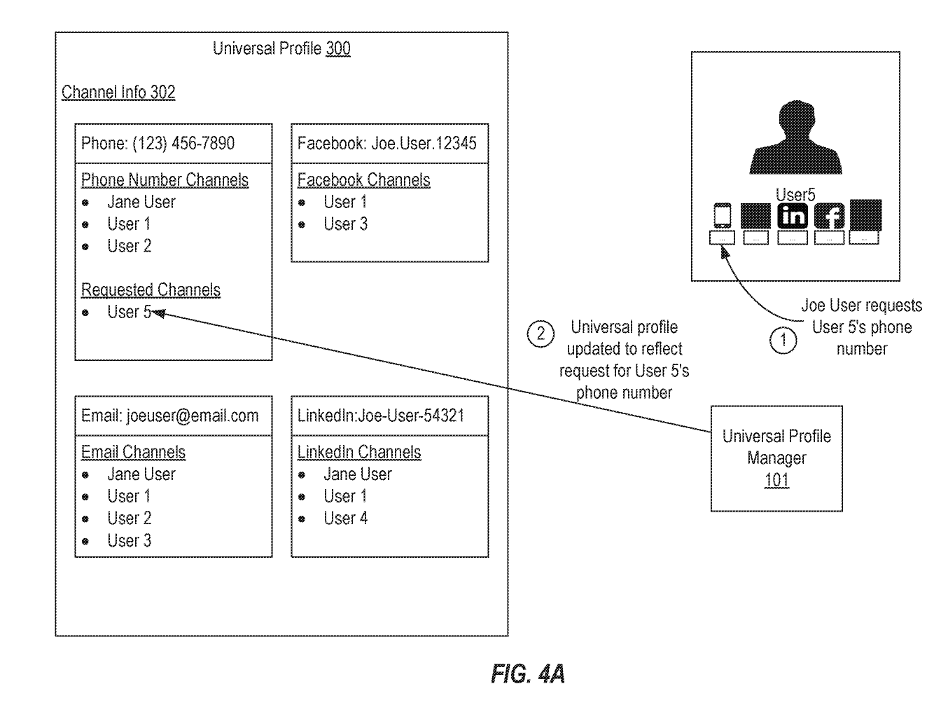

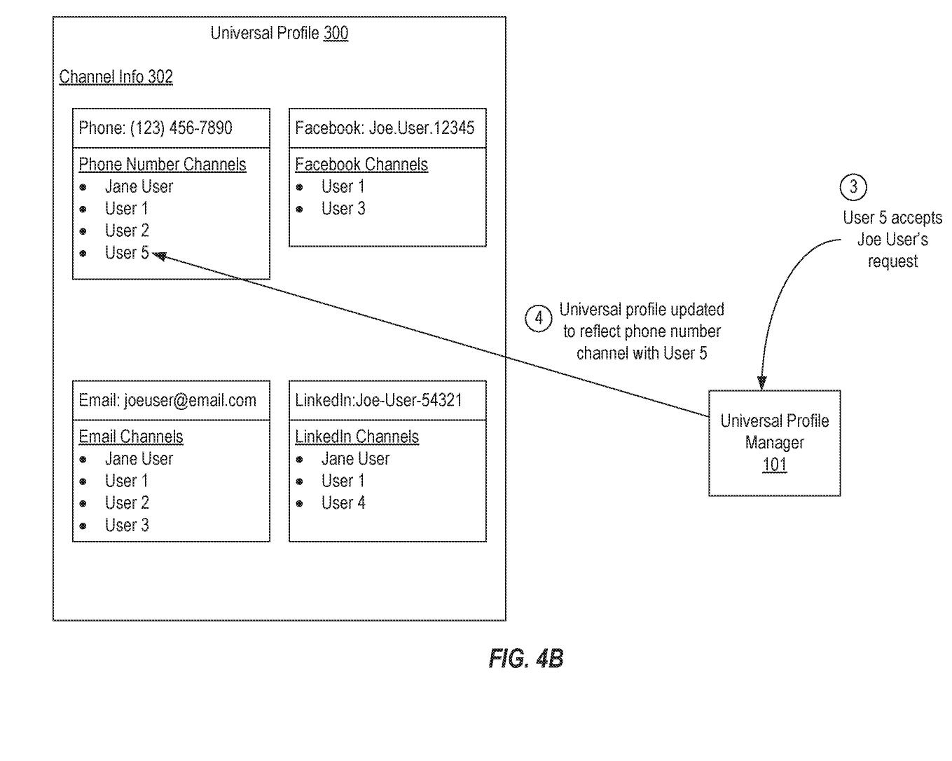

FIGS. 4A and 4B illustrate an example of the process for manually creating a channel. In FIG. 4A, it is assumed that Joe User is viewing User 5's universal profile. As shown, User 5 is assumed to have included five endpoints in his universal profile: a phone number endpoint, an email endpoint, a LinkedIn endpoint, a Facebook endpoint, and a Twitter endpoint. Because Joe User has included phone number, email, LinkedIn, and Facebook endpoints in universal profile, he can be allowed to request the establishment of a channel using any of these endpoints. However, since Joe User has not included a Twitter endpoint, he may not be allowed to establish a Twitter channel with User 5.

In step 1, Joe User provides input to request User 5's phone number (e.g., by selecting the Request Phone element displayed by the phone icon). In response to this input, a request can be sent to User 5 indicating that Joe User would like User 5's phone number. Also, as shown in step 2, universal profile manager 101 can update Joe User's universal profile 300 so that phone number endpoint 300a includes an indication of a requested channel with User 5. As mentioned above, any suitable data structure could be employed for storing this information. In some cases, a separate table may be employed to store requested channels. Regardless of the exact format of the underlying data structure(s), an indication of the requested channel can be stored in a manner that associates the indication with universal profile 300. Also, if User 5 had instead requested Joe User's phone number, a similar indication could have been added to universal profile 300 to define that User 5 has requested Joe User's phone number. A primary reason for storing these indications of requested channels is to allow the status of a channel to be presented to the user. For example, if Joe User were to again view User 5's universal profile, the universal profile could be displayed with an indication that Joe User has already requested User 5's phone number.

Turning to FIG. 4B, it is assumed that User 5 accepts Joe User's request and therefore universal profile manager 101 is notified accordingly in step 3. In response, universal profile manager 101 can update universal profile 300 in step 4 so that phone number endpoint 300a reflects the channel with User 5. Accordingly, after step 4, Joe User will have established four phone number channels within social networking platform 100 (i.e., Joe User will have access to the phone numbers of four users of social networking platform 100). Based on these defined channels, if Joe User were to view the universal profile of any of Jane User, User 1, User 2, or User 5, Joe User would be able to view the phone number defined in that universal profile.

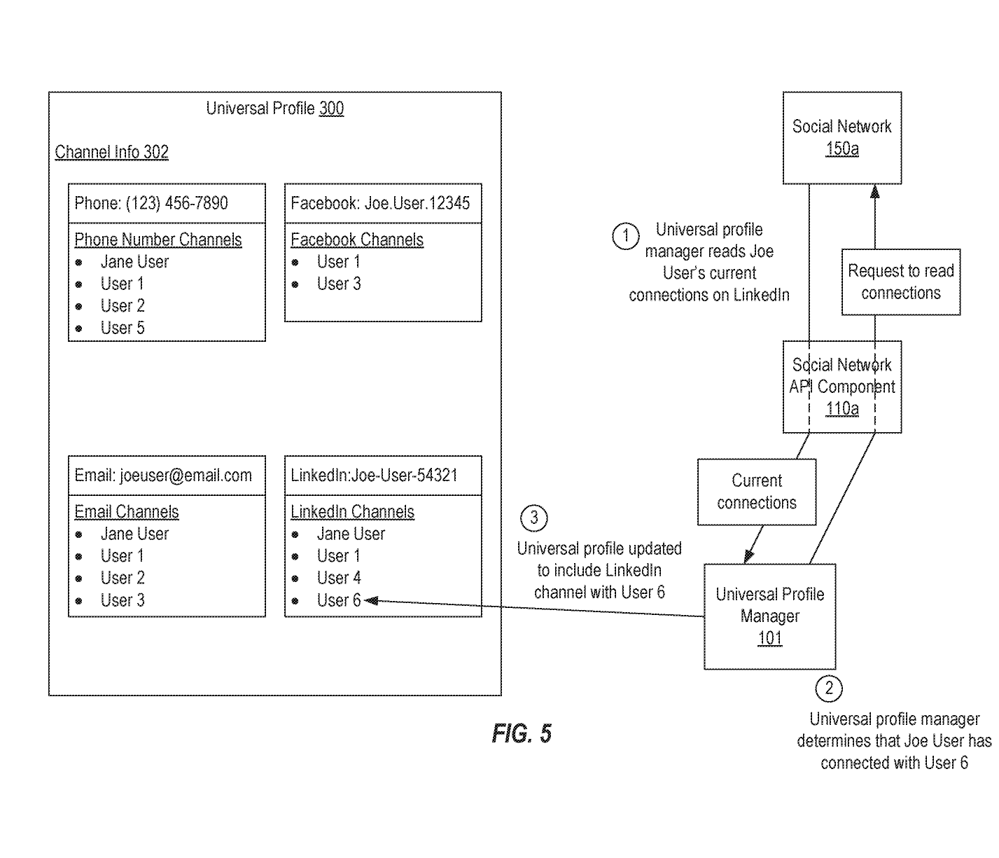

FIG. 5 illustrates an example of the process for automatically creating a channel in response to accessing a user's profile with another social networking platform. In FIG. 5, it will be assumed that Joe User has independently connected with User 6 on LinkedIn. For example, Joe User could have logged into the LinkedIn website and connected with User 6 outside of social networking platform 100. It will also be assumed that User 6 has a universal profile that includes a LinkedIn endpoint.

In step 1, universal profile manager 101 is shown as sending a request to read Joe User's LinkedIn connections. This request can be sent via social network API component 110a and could be performed as part of a periodic or on demand update routine. In response, universal profile manager 101 will receive Joe User's current connections on LinkedIn. In step 2, universal profile manager 101 can evaluate Joe User's current LinkedIn connections to determine whether any new connections exist with other users of social networking platform 100. Because Joe User is now connected with User 6 and User 6 includes a universal profile that includes a LinkedIn profile, universal profile manager 101 will determine that a LinkedIn channel should exist between Joe User and User 6. Therefore, in step 3, universal profile manager 101 can update universal profile 300 so that LinkedIn endpoint 300c includes a channel with User 6. Although not shown, a similar update could be made to User 6's universal profile.

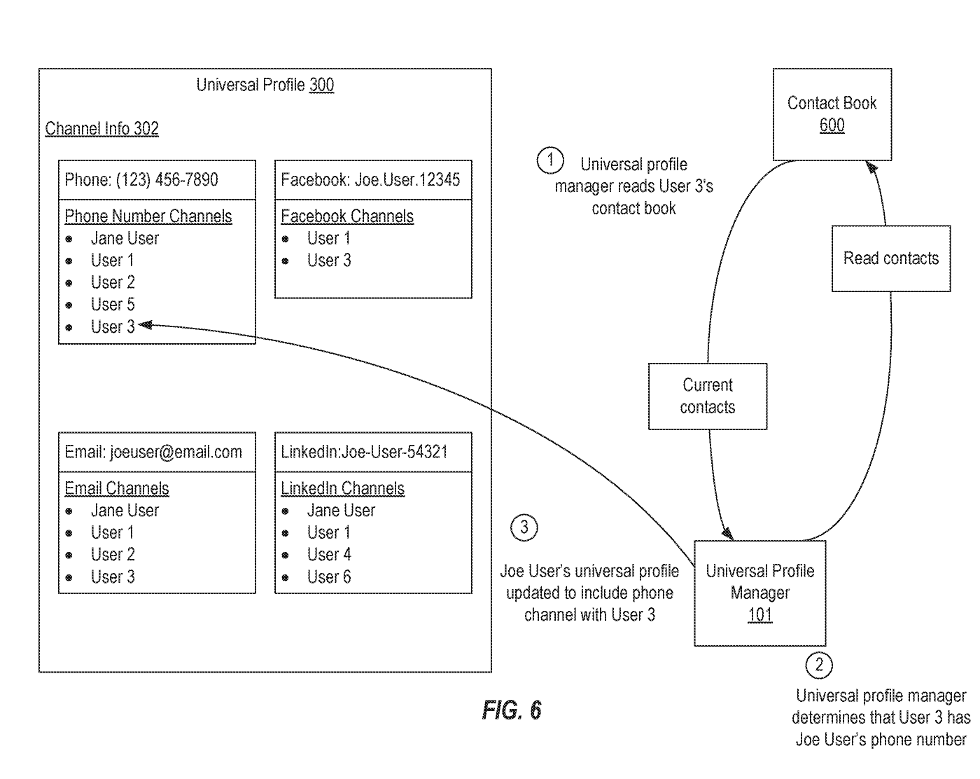

FIG. 6 illustrates an example of the process for automatically creating a channel in response to accessing a user's contact book 600. In FIG. 6, it will be assumed that contact book 600 is User 3's contact book and that User 3 has previously added Joe User's phone number to his contact book 600. In other words, User 3 has added, to his contact book, the phone number (123-456-7890) that Joe User has included in his universal profile.

In step 1, universal profile manager 101 (which may be an instance that is executing on User 3's mobile device) requests to read User 3's contacts in contact book 600 and therefore obtains the current contacts. In step 2, universal profile manager 101 can evaluate the current contacts to determine whether the phone number of any user of social networking platform 100 is stored in contact book 600. In this example, it is assumed that universal profile manager 101 will identify the presence of Joe User's phone number in contact book 600. In response, universal profile manager 101 can update (or cause the update of) Joe User's universal profile 300 so that phone number endpoint 300a defines a phone number channel with User 3.

In any instance when it is determined that a channel could be automatically created, universal profile manager 101 may cause a prompt to be displayed to the user to request confirmation before creating the channel. In other embodiments, however, a channel may be automatically created without requiring user confirmation or approval. Also, in some embodiments, a channel may be created automatically only when a channel already exists with the user. For example, when accessing contact book 600, universal profile manager 101 may only search for phone numbers of users with which Joe User has established an email channel, LinkedIn channel, or Facebook channel. Limiting the automatic creation of channels in this manner can minimize the amount of processing that would otherwise be required to compare a user's contacts/connections to every user of social networking platform 100.

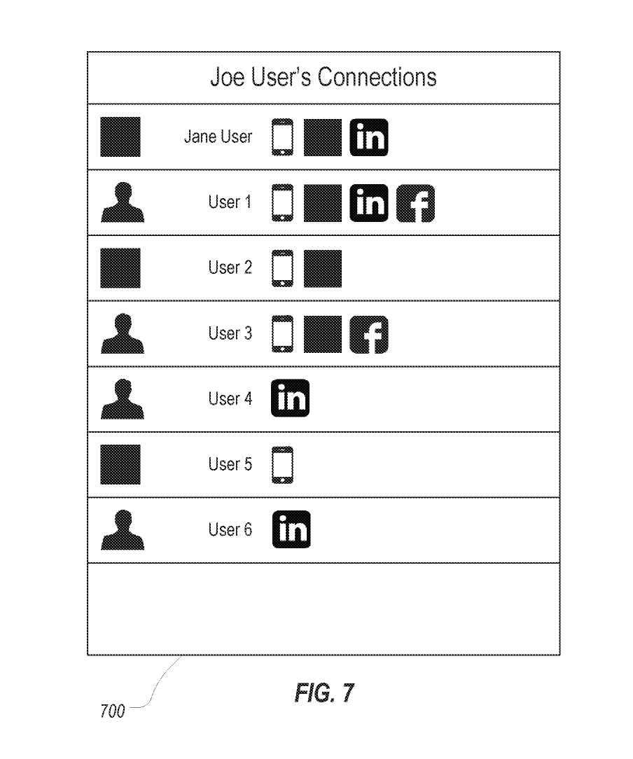

FIG. 7 provides an example of a user interface 700 in which Joe User's connections are displayed. As mentioned above, a user is connected with another user in social networking platform 100 if the user has established at least one channel with the other user. User interface 700 can be generated based on the contents of Joe User's universal profile 300, or more particularly, based on the channels defined in each of endpoints 300a-300d. Each of Joe User's connections is displayed in conjunction with an indication of which channels Joe User has established with the connection. For example, Jane User is displayed in conjunction with the phone, email, and LinkedIn icons since Joe User has established phone number, email, and LinkedIn channels with Jane User. In some embodiments, this view of Joe User's connections can be displayed only to Joe User and his connections, while in other embodiments, any user of social networking platform 100 may be able to view Joe User's connections.

Returning to FIG. 1, social networking platform 100 is shown as including a location component 102 which can typically represent client-side and server-side components that are configured to identify a location of a user as well as other nearby users. For example, location component 102 can include any available sensors/components on a mobile device that can provide location information obtained in any suitable manner including, for example, via GPS, Bluetooth, WiFi, MultiPeer, etc. Location component 102 can also represent the server-side components that receive the location of users and identify which users are nearby another user.

In accordance with embodiments of the present invention, location component 102 can include functionality for tracking which users are nearby another user during a particular time period. The identity of these tracked users can be stored in conjunction with a user's universal profile so that the user can review the tracked users at a later time and determine whether to connect with any of them.

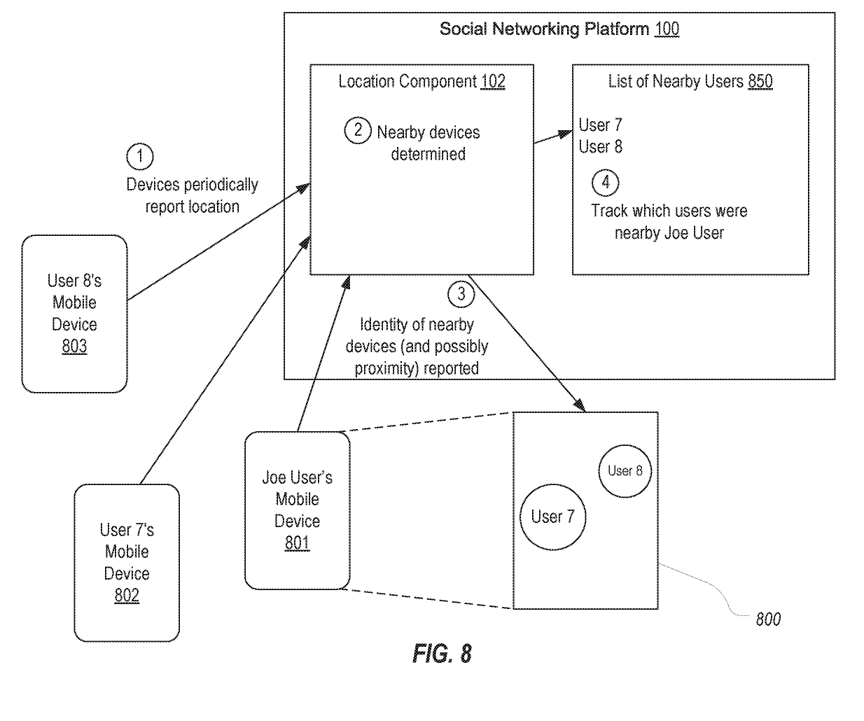

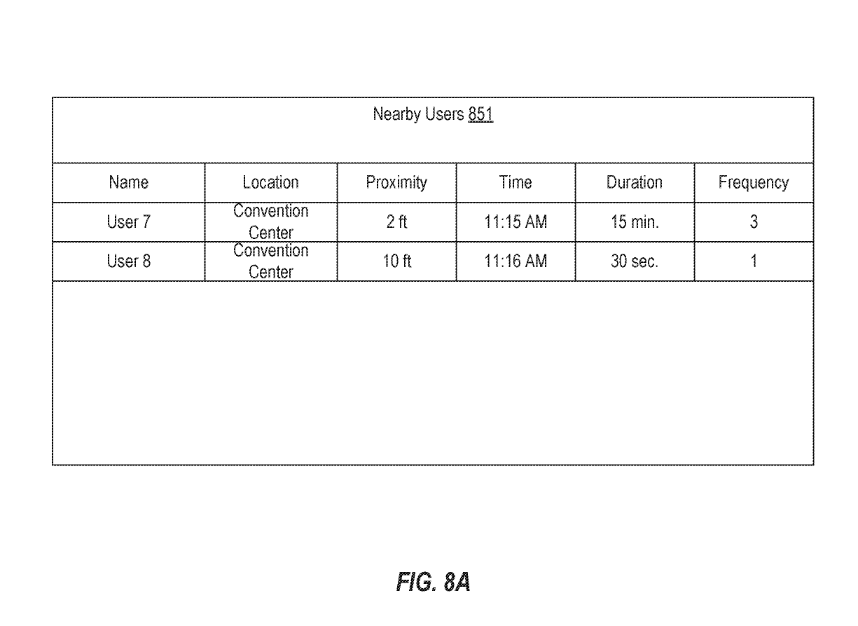

FIG. 8 illustrates an example of how this tracking process can be performed. Since it is known how to identify nearby users, this process will not be described in detail. Suffice it to say that each user's mobile device can periodically report its location to location component 102 (i.e., the server-side portion of location component 102) in step 1 to allow location component 102 to identify which users are nearby another user in step 2. In FIG. 8, Joe User is assumed to be logged into his account on mobile device 801 while two other users, User 7 and User 8, are also logged into their accounts on mobile devices 802 and 803 respectively. Assuming that the locations reported by mobile devices 802 and 803 are within some threshold distance of the location reported by mobile device 801, location component 102 can determine that Users 7 and 8 are nearby Joe User and cause Joe User's mobile application to display that these users are nearby in step 3.

For example, FIG. 8 depicts a user interface 800 that can be displayed to Joe User and which identifies that User 7 and User 8 are nearby. In some embodiments, when a nearby user is displayed, the proximity of the nearby user can be represented. For example, user interface 800 can include an element (which in this case is a circle) for each nearby user. The size of the element can be used to identify how close the user is. User 7's circle is larger than User 8's circle to represent that User 7 is in closer proximity to Joe User than User 8. Accordingly, user interface 800 can be generated based not only on the identity of nearby users, but also on the proximity of each identified nearby user. User interface 800 can be dynamically updated as each user moves around, or more particularly, as each user's device reports an updated location.

In addition to providing Joe User a real-time indication of which users are nearby, location component 102 can also maintain a listing of any users that were nearby Joe User during a period of time. Accordingly, in step 4, location component 102 updates a list 850 of nearby users that is associated with Joe User to reflect that Users 7 and 8 were nearby. For example, list 850 could form part of or be associated with Joe User's universal profile 300. List 850 could be configured to maintain an indication of a nearby user for a specified amount of time. For example, at any given time, list 850 may include an indication of all users that were nearby Joe User in the past 24 hours. Location component 102 may also store a number of different parameters relating to the detected proximity of a user including a location of Joe User when the identified user was nearby, a proximity (e.g., the minimum distance between Joe User and the identified user), a time when the identified user was detected as being nearby, and a duration of time when the identified user was nearby.

FIG. 8A provides an example of how the contents of list 850 can be displayed to Joe User within a Nearby User user interface 851. In this example, it is assumed that Joe User was located nearby User 7 and User 8 while at a convention center. Based on the reported locations, it was determined that User 7 was located two feet from Joe User while User 8 was located ten feet from Joe User. Also, User 7 and User 8 were first determined to be located nearby Joe User at 11:15 and 11:16 respectively. Based on continued reports of location, it was determined that User 7 remained nearby for 15 minutes while User 8 remained nearby for 30 seconds. Finally, User 7 was determined to be nearby on three separate occasions (i.e., User 7 came within a threshold proximity of Joe User on three different occasions) while User 8 was only detected nearby on one occasion. All of this information is assumed to have been stored in list 850.

Based on the information in list 850, a user interface 851 can be generated to allow Joe User to review which users he was nearby during a previous time period. For example, at the end of a day spent at a convention, Joe User may access user interface 851 to see who he was nearby and to identify particular users that he may want to connect with. In this way, Joe User will not need to access his mobile device during the convention to create a connection and will not need to remember a user's name to make the connection later. Joe User can simply wait until returning from the convention to review the list of nearby users and identify any desired user that he was nearby. The additional information presented in user interface 851 can facilitate this.

Upon selecting a user in user interface 851, Joe User can be presented with the universal profile of the selected user. For example, if Joe User selects User 7, a user interface similar to user interface 301 can be displayed containing User 7's information and providing Joe User with the opportunity to request the establishment of a channel with User 7 via any available endpoint.

In some embodiments, location component 102 can be configured to locate nearby users using a variety of location techniques in order to prolong battery life and to better identify nearby users in crowded environments. For example, whenever GPS is available, location component 102 can employ the GPS data to identify a user's location. However, if GPS data is not available (e.g., within a building) and/or when a large number of users are located in close proximity, location component 102 can switch over to using a peer-to-peer detection technique. For example, in a crowded environment, the users' devices can be configured to communicate with each other over Bluetooth, WiFi, or another wireless protocol to identify other nearby devices. In such cases, the client-side portion of location component 102 can be configured to report nearby users to the server-side portion of location component 102 based on these peer-to-peer detections.

In some embodiments, social networking platform 100 can allow a user to block any other user from seeing the user's universal profile and/or location. For example, if a first user blocks a second user, the second user will not be able to see the first user in search or location results and will therefore not be able to connect with the first user in any manner. In some embodiments, a user may be able to specify that his or her location not be tracked or displayed to any other user.

In some embodiments, social networking platform 100 can provide a feed of connections that are being made by a user's connections. For example, if Jane User connects with User 9, Joe User's feed could be updated to reflect the connection. The feed can include details about the connection including which channel(s) were established. This feed can therefore provide an indication of which channels are being used most frequently to create connections. In some embodiments, the feed may also display an indication when a user's friend/connection on another social networking platform (e.g., Facebook or LinkedIn) joins (i.e., creates a universal profile) on social networking platform 100. Also, in some embodiments, the feed may display when a user's connections on social networking platform 100 add an endpoint to their universal profiles. For example, if Jane User adds a new endpoint to her universal profile, Joe User's feed could be updated to reflect this thereby encouraging Joe User to establish a new channel with Jane User via the new endpoint.

In some embodiments, social networking platform 100 can be configured to provide a user with suggestions of other users to connect with. A variety of algorithms may be employed to identify a suggestion. For example, a relationship-based algorithm may identify that a second user, to whom a first user is connected, has a number of connections that the first user does not share in common. The relationship-based algorithm may then determine how many connections each of the second user's connections have and rank the second user's connections accordingly. This ranking process can be performed on the connections of any of the first user's connections which the highest ranked connections then being presented to the first user as suggestions. For example, if Joe User is connected to Jane User, Jane User is connected to Jack User, and Jack User has many connections, Jack User may receive a high ranking when identifying which users to suggest to Joe User.

A one-way connection algorithm may be employed to identify when a first user has established a “one-way” channel with a second user. For example, if the second user has the first user's phone number but the first user does not have the second user's phone number, a one-way channel would exist. In such cases, social networking platform 100 may suggest that the first user request the phone number of the second user to thereby form a “two-way” channel.

A similarity algorithm can be employed to identify non-connections that are similar to a user's connections. For example, if Joe User is connected to Jane User and a number of users that are similar to Jane User (e.g., based on an analysis of the user's universal profiles), social networking platform 100 may identify other users that are similar to Jane User and suggest that Joe User connect with them.

A missing channel algorithm can be employed to identify when connected users could establish another channel between themselves. For example, if a first user and a second user have established a phone number channel and both users have Facebook endpoints, social networking platform 100 can suggest that the users establish a Facebook channel.

A long-term location algorithm can be employed to identify other users that have been located nearby a user over a long period of time. For example, in contrast to what is described above regarding the tracking of nearby users over a relatively short period of time, social networking platform 100 may track users' locations over days or months to identify which users may work, recreate, or live nearby one another. If two users are determined to be routinely located within the same location (i.e., within a threshold distance) over a long-term period (such as would be the case if the users worked in the same building), social networking platform 100 may suggest that the users connect.

With each of the above described algorithms, a ranking or score can be generated for each potential suggestion. Then, the potential suggestions with the highest rankings or scores can be presented to the user as suggestions. In some embodiments, social networking platform 100 can provide an option to hide a suggestion or may automatically detect that a suggestion should be hid (e.g., by determining that the user to whom the suggestion is presented has not acted on the suggestion over repeated appearances of the suggestion or has opened the suggested user's universal profile but has failed to interact with the suggested user). In such cases, if the user to whom the suggestion is made selects to hide the suggestion or it is determined based on user interaction or lack thereof that the suggestion should be hid, a negative weighting can be added into the algorithms to cause the suggested user's ranking or score to be reduced thereby preventing the user from again being suggested even if the algorithms would otherwise generate a high ranking or score. For example, if a first user and a second user have many connections in common and work in the same building, the above-described algorithms may generate a high ranking or score for purposes of determining whether one user should be suggested to the other. If, for example, the second user is suggested to the first user and the first user requests to hide the second user, a negative weighting can be added to “offset” the fact that the two users share many connections and work in the same building. In some embodiments, this negative weighting can diminish over time so that the hidden suggestion will eventually be suggested again (assuming that the algorithms would still produce a high ranking or score).

A user can be allowed to share his or her universal profile in many different ways. For example, each universal profile can include a unique URL that can be provided on a webpage or included in an email or text. This can allow a user to easily share his or her own universal profile or the universal profile of other users.

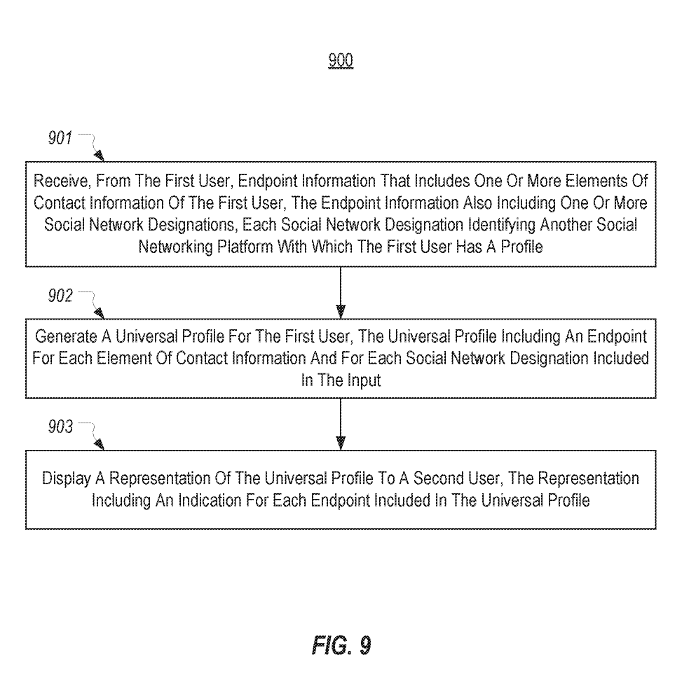

FIG. 9 illustrates a flowchart of an example method 900 for creating a universal profile for a first user of a first social networking platform. Method 900 can be performed by social networking platform 100 and will be described with reference to the figures.

Method 900 includes an act 901 of receiving, from the first user, endpoint information that includes one or more elements of contact information of the first user, the endpoint information also including one or more social network designations, each social network designation identifying another social networking platform with which the first user has a profile. For example, universal profile manager 101 can receive input 201.

Method 900 includes an act 902 of generating a universal profile for the first user, the universal profile including an endpoint for each element of contact information and for each social network designation included in the input. For example, universal profile manager 101 can create universal profile 300 that includes endpoints 300a-300d.

Method 900 can include an act 903 of displaying a representation of the universal profile to a second user, the representation including an indication for each endpoint included in the universal profile. For example, user interface 301 can be provided to display universal profile 300.

Embodiments of the present invention may comprise or utilize special purpose or general-purpose computers including computer hardware, such as, for example, one or more processors and system memory. Embodiments within the scope of the present invention also include physical and other computer-readable media for carrying or storing computer-executable instructions and/or data structures. Such computer-readable media can be any available media that can be accessed by a general purpose or special purpose computer system.

Computer-readable media is categorized into two disjoint categories: computer storage media and transmission media. Computer storage media (devices) include RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other similarly storage medium which can be used to store desired program code means in the form of computer-executable instructions or data structures and which can be accessed by a general purpose or special purpose computer. Transmission media include signals and carrier waves.

Computer-executable instructions comprise, for example, instructions and data which, when executed by a processor, cause a general purpose computer, special purpose computer, or special purpose processing device to perform a certain function or group of functions. The computer executable instructions may be, for example, binaries, intermediate format instructions such as assembly language or P-Code, or even source code.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like.

The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices. An example of a distributed system environment is a cloud of networked servers or server resources. Accordingly, the present invention can be hosted in a cloud environment.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description.

What is claimed:

1. A method for creating a universal profile for a first user of a first social networking platform, the method comprising:
receiving, from the first user, endpoint information that includes one or more elements of contact information of the first user, the endpoint information also including one or more social network designations, each social network designation identifying another social networking platform with which the first user has a profile;
generating a universal profile for the first user, the universal profile including an endpoint for each element of contact information and for each social network designation included in the input; and
displaying a representation of the universal profile to a second user, the representation including an indication for each endpoint included in the universal profile.

2. The method of claim 1, wherein the one or more elements of contact information include a phone number and an email address of the first user.

3. The method of claim 1, wherein generating the universal profile for the first user comprises accessing the first user's profile with one of the other social networking platforms to obtain the first user's connections on the other social networking platform.

4. The method of claim 3, further comprising:
comparing the first user's connections on the other social networking platform to universal profiles on the first social networking platform to identify one or more of the first user's connections on the other social networking platform that have a universal profile on the first social networking platform.

5. The method of claim 4, further comprising:
for each of the one or more identified connections, updating the universal profile of the first user to include an identification of each of the one or more identified connections within a social network endpoint corresponding to the other social networking platform thereby defining that a social network channel exists between the first user and each of the one or more identified connections.

6. The method of claim 1, further comprising:
receiving input from the second user that selects the indication for a first endpoint in the universal profile, the first endpoint representing a phone number or email address of the first user such that the input represents a request to receive the first user's phone number or email address;
providing a notification to the first user indicating that the second user has requested the first user's phone number or email address; and
in response to the first user providing input to accept the request, updating a universal profile of the second user to include an identification of the first user within a phone number endpoint or email endpoint to identify that a phone number channel or email channel has been created with the first user.

7. The method of claim 1, further comprising:
receiving input from the second user that selects the indication for a second endpoint in the universal profile, the second endpoint representing the first user's account with one of the other social networking platforms;
providing a notification to the first user indicating that the second user has requested to connect with the first user on the other social networking platform; and
in response to the first user providing input to accept the request, updating the universal profile of the first user to include an identification of the second user within a social network endpoint corresponding to the other social networking platform thereby defining that a social network channel exists between the first user and the second user.

8. The method of claim 7, further comprising:
updating the universal profile of the second user to include an identification of the first user within a social network endpoint corresponding to the other social networking platform thereby defining that a social network channel exists between the first user and the second user.

9. The method of claim 7, further comprising:
accessing the other social networking platform to create a connection between the first and second users on the other social networking platform.

10. The method of claim 1, further comprising:
accessing a contact book of the first user;
comparing one or more phone numbers or email addresses contained in the contact book to phone numbers or email addresses defined in universal profiles of other users of the first social networking platform; and
upon identifying a phone number or email address in the contact book that matches a phone number or email address in a universal profile of another user, updating the universal profile of the first user to include an identification of the other user within a phone number endpoint or email endpoint thereby defining that a phone number channel or email channel exists between the first user and the other user.

11. The method of claim 1, further comprising:
detecting a location of the first user at a particular time;
detecting a location of another user at the particular time;
determining that the other user is nearby the first user at the particular time;
storing an indication that the other user was nearby the first user at the particular time; and
at a later time, displaying to the first user that the other user was nearby the first user at the particular time.

12. The method of claim 11, wherein displaying to the first user that the other user was nearby the first user at the particular time includes displaying one or more of:
a distance between the first user and the other user at the particular time;
an amount of time that the other user remained nearby the first user;
a location of the first user when the other user was nearby; or
a number of times that the other user was determined to have come nearby the first user.

13. The method of claim 12, further comprising:
receiving input from the first user that selects the other user;
displaying a representation of a universal profile of the other user, the representation including an indication of each endpoint included in the universal profile of the other user;
receiving input from the first user that selects one of the endpoints in the universal profile of the other user, the input comprising a request to create a channel with the other user via the selected endpoint; and
in response to the other user approving the request, updating the universal profile of the first user to define that a channel has been created with the other user via the selected endpoint.

14. The method of claim 13, wherein the selected endpoint is one of a phone number endpoint, an email address endpoint, or a social networking endpoint.

15. One or more computer storage media storing computer executable instructions which when executed by one or more processors of one or more computing devices implement a method for creating a universal profile for a first user of a first social networking platform, the method comprising:
receiving, from the first user, endpoint information that includes a phone number, an email address, and a social network designation which identifies another social networking platform with which the first user has a profile;
generating a universal profile for the first user, the universal profile including a phone number endpoint, an email endpoint, and a social network endpoint that are generated based on the endpoint information.

16. The computer storage media of claim 15, wherein the method further comprises:
updating the phone number endpoint or the email endpoint to include an identification of another user of the first social networking platform, wherein updating comprises one of:
manually updating the phone number endpoint or the email endpoint to include an identification of another user when the other user approves a request from the first user to share the other user's phone number or email address respectively; or
automatically updating the phone number endpoint or email endpoint to include an identification of another user when the other user's phone number or email address is located in a contact book of the first user.

17. The computer storage media of claim 15, wherein the method further comprises:
updating the social network endpoint to include an identification of another user of the first social networking platform upon detecting that the first user and the other user are connected on the other social networking platform.

18. The computer storage media of claim 15, wherein the method further comprises:
detecting a location of the first user at a particular time;
detecting a location of another user at the particular time;
determining that the other user is nearby the first user at the particular time;
storing an indication that the other user was nearby the first user at the particular time; and
at a later time, displaying to the first user that the other user was nearby the first user at the particular time.

19. The computer storage media of claim 18, wherein displaying to the first user that the other user was nearby the first user at the particular time includes displaying one or more of:
a distance between the first user and the other user at the particular time;
an amount of time that the other user remained nearby the first user;
a location of the first user when the other user was nearby; or
a number of times that the other user was determined to have come nearby the first user.

20. A social networking platform comprising:
one or more servers on which universal profiles of users of the social networking platform are stored, each universal profile defining at least one endpoint;
a mobile application configured to communicate with the one or more servers, each mobile application being configured to report a location of a corresponding user of the social networking platform;
wherein the one or more servers are configured to detect, during a period of time, when one or more other users are nearby a first user and to store, for each nearby user, an identification of the nearby user; and
wherein the one or more servers are configured to display, to the first user and at a time subsequent to the period of time, each stored identification thereby enabling the first user to identify which users were nearby during the period of time.
